(19) United States
(12) Patent Application Publication
(10) Pub. No.: US 2009/0183264 A1
(43) Pub. Date: Jul. 16, 2009

(54) SYSTEM AND METHOD FOR PROTECTING CONTENT IN A WIRELESS NETWORK

(75) Inventors: Mazen Chmaytelli, San Diego, CA (US); Laurence G. Lundblade, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/329,273

(22) Filed: Dec. 5, 2008

Related U.S. Application Data
(60) Provisional application No. 61/020,841, filed on Jan. 14, 2008.

(51) Int. Cl. H04L 9/32

(52) U.S. Cl. 726/28

(57) ABSTRACT

A method of providing access to content within a user device is disclosed and may include determining a location of the content, determining whether the content is within an allowed region, and selectively prompting a user to purchase a license to access the content. In a particular aspect, the user may be prompted to purchase the license to the access the content when the content is not within an allowed region. If the license is purchased, the user may be allowed to access the content. The license may be an unlimited license, a limited license, or a transfer license.

This Application both claims to priority, and incorporates the entire content of, U.S. Provisional Patent Application No. 61/020,841 entitled “SYSTEM AND METHOD FOR PROTECTING CONTENT IN A WIRELESS NETWORK” and filed on Jan. 14, 2008.

### FIELD

The present invention generally relates to the operation of data networks, and more particularly, to systems and methods for protecting content in wireless data networks.

### DESCRIPTION OF THE RELATED ART

Advances in technology have resulted in the development and deployment of extensive data networks. These networks include both public data networks, such as the Internet, and specialized networks, such as wireless telecommunication networks. Users of these networks have the ability to access a wide variety of information and services that are available as network resources.

One example where there is an increasing demand for network resources is in wireless network environments. In wireless environments, a variety of wireless devices, such as wireless telephones, personal digital assistants (PDAs), and paging devices, communicate over a wireless network. The wireless network may also include network servers that operate to provide various network resources to the wireless devices. Furthermore, the wireless networks may also be coupled to a public network, such as the Internet, so that resources on the public network may be made available to the wireless devices on the wireless network.

One area of concern for application and content developers is that of content protection. Content protection is becoming very important in wireless networks due to the improvements in air-link data speeds and the proliferation of end-users purchasing applications and related content via wireless devices. For example, applications and content purchased by one device user may be easily distributed to other device users. As a result, it is possible for device users to avoid paying various purchase and license fees to application and content developers. Thus, application developers and content providers must address the problem of having their applications or content pirated and/or distributed to other wireless devices or desktop computers without receiving the associated fees.

Therefore, what is needed is a system that operates to protect applications and content from unauthorized acquisition, operation, and/or distribution.

### SUMMARY OF THE DISCLOSURE

A method of providing access to content within a user device is disclosed and may include determining a location of the content, determining whether the content is within an allowed region, and selectively prompting a user to purchase a license to access the content.

In another aspect, a wireless device used to access content is disclosed. The wireless device may include means for determining a location of the content, means for determining whether the content is within an allowed region, and means for selectively prompting a user to purchase a license to access the content.

In yet another aspect, a server providing access to content is disclosed. The server may include means for determining a location of the content, means for determining whether the content is within an allowed region, and means for selectively prompting a user to purchase a license to access the content.

In still another aspect, a computer program product having a computer-readable medium is disclosed and the computer-readable medium may include at least one instruction for determining a location of the content, at least one instruction for determining whether the content is within an allowed region, and at least one instruction for selectively prompting a user to purchase a license to access the content.

In another aspect, a method of controlling superdistribution of content from a user device to a target device is disclosed and includes determining a location of the target device, determining whether the target device is within an allowed region, and selectively blocking superdistribution of the content to the target device based on the location of the target device.

In still yet another aspect, a wireless device used to access content is disclosed and may include means for determining a location of the target device, means for determining whether the target device is within an allowed region, and means for selectively blocking superdistribution of the content to the target device based on the location of the target device.

In still yet another aspect, a server providing access to content is disclosed and may include means for determining a location of the target device, means for determining whether the target device is within an allowed region, and means for selectively blocking superdistribution of the content to the target device on the location of the target device.

In another aspect, a computer program product having a computer-readable medium is disclosed and the computer-readable medium may include at least one instruction for determining a location of the target device, at least one instruction for determining whether the target device is within an allowed region, at least one instruction for selectively blocking superdistribution of the content to the target device on the location of the target device.

In yet another aspect, a method of providing superdistribution of content from a user device to a target device is disclosed and may include allowing superdistribution of the content, determining a location of the target device, and selectively blocking access to the content.

In still another aspect, a wireless device used to access content is disclosed and may include means for allowing superdistribution of the content, means for determining a location of the target device, and means for selectively blocking access to the content.

In still yet another aspect, a server providing access to content is disclosed and may include means for allowing superdistribution of the content, means for determining a location of the target device, and means for selectively blocking access to the content.

In another aspect, a computer program product having a computer-readable medium is disclosed and may include at least one instruction for allowing superdistribution of the content, at least one instruction for determining a location of the target device, and at least one instruction for selectively blocking access to the content.

In yet another aspect, a wireless device is disclosed and may include a global identifier table. The global identifier table may include at least one content identifier associated with content and at least one geographic identifier associated with the content identifier. The geographic identifier indicates an area within which the content is accessible.

In still another aspect, a method of dynamically updating a global identifier table associated with content is disclosed and may include associating content with a region via a geographic identifier, distributing the content, and storing a content identifier and the geographic identifier within the global identifier table. Further, the method may include selectively controlling access to the content at least partially based on the location of the content and the geographic identifier and selectively determining whether the region associated with the content changes.

In yet another aspect, a wireless device for accessing content is disclosed and may include means for storing a content identifier and the geographic identifier within the global identifier table, means for selectively controlling access to the content at least partially based on the location of the content and the geographic identifier, and means for selectively determining whether the region associated with the content changes.

In another aspect, a server is disclosed and may include means for associating content with a region via a geographic identifier, means for distributing the content, and means for storing a content identifier and the geographic identifier within the global identifier table. Further, the server may include means for selectively controlling access to the content at least partially based on the location of the content and the geographic identifier and means for selectively determining whether the region associated with the content changes.

In yet another aspect, a computer program product having a computer-readable medium is disclosed and the computer-readable medium may include at least one instruction for associating content with a region via a geographic identifier, at least one instruction for distributing the content, and at least one instruction for storing a content identifier and the geographic identifier within the global identifier table. Additionally, the computer-readable medium may include at least one instruction for selectively controlling access to the content at least partially based on the location of the content and the geographic identifier, and at least one instruction for selectively determining whether the region associated with the content changes.

### BRIEF DESCRIPTION OF THE DRAWINGS

In the figures, like reference numerals refer to like parts throughout the various views unless otherwise indicated.

FIG. 1 is a diagram of a data network;

FIG. 2 is a diagram of a protection system;

FIG. 3 is a diagram of a telephone;

FIG. 4 is a flowchart illustrating a method of providing access to content;

FIG. 5 is a flowchart illustrating a method of providing superdistribution of content;

FIG. 6 is a flowchart illustrating another aspect of a method of providing superdistribution of content; and

FIG. 7 is a flowchart illustrating a method of dynamically updating a global identifier table associated with content.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, an “content” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

One or more aspects described herein provide a way to protect content from unauthorized access or unauthorized superdistribution. A user may purchase content digitally, but the content may have limited access based on a geographic region associated with the content or a device in which the content resides. For example, a particular song may be available for listening in a first region, but unavailable for listening in a second region. However, when the user is in the second region, he or she may be prompted to purchase a license to access the content in the second region.

Another aspect may protect superdistribution of content. For example, a first user may purchase content that is accessible in a first region. However, if the first user attempts to superdistribute the content to a second user and the second user is not located in the first region, superdistribution of the content may be blocked. Alternatively, superdistribution of the content may be allowed but access to the content by the second user may be blocked, unless the second user purchases a license to access the content.

In a particular aspect, the device itself may determine the location of the content and determine whether the content is accessible. Alternatively, a platform or client framework within the device may determine the location of the content and determine whether the content is accessible. For example, a wireless device may include a media player and when the media player is used to access content, e.g., a song, the media player application within the wireless device may execute one or more of the methods described herein, not the device itself.

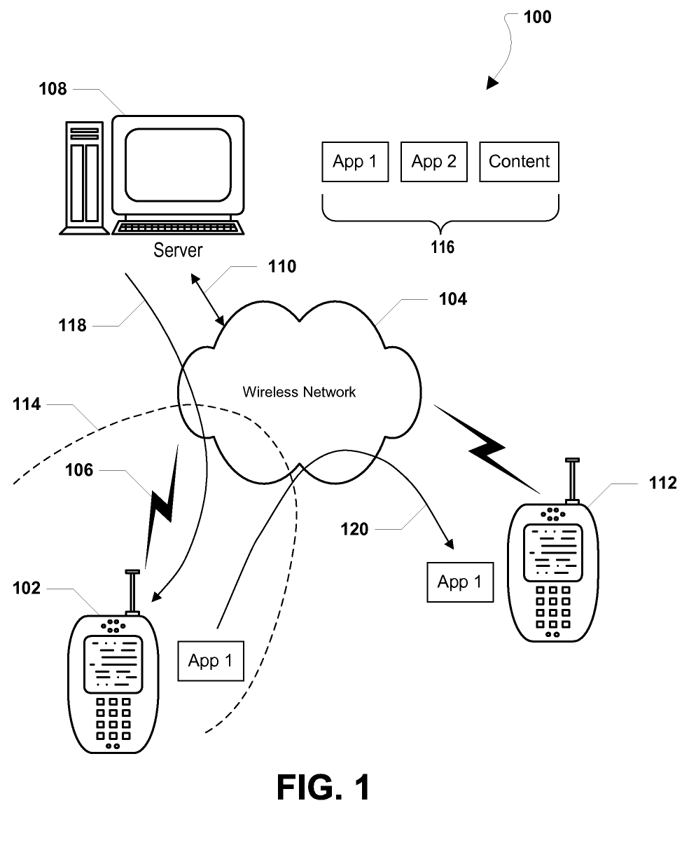

FIG. 1 shows a data network 100 that includes one aspect of a protection system for protecting applications and/or content from unauthorized acquisition and/or distribution. The network 100 may include a wireless device 102 that communicates with a wireless data network 104 via a wireless communication channel 106. The network 100 may also include a server 108 that operates to provide services to the wireless device 102 and other entities in communication with the wireless data network 104. The server 108 may be coupled to the network 104 by link 110, which may be any type of wired or wireless link. For example, in one aspect, the wireless device 102 may be a wireless telephone, and the server 108 may be part of a nationwide telecommunications network that provides applications and/or multimedia content to the wireless device 102. A second wireless device 112 may also be coupled to the network 104. The second wireless device 112 may be located in a different geographic from the wireless device 102.

During operation of the protection system, content provided by the server 108 to the wireless device 102 may be protected so that the content is only accessible when the wireless device 102 is in a selected geographic region. For example, in one aspect, the server 108 may include various applications and content 116 that are available for download to the wireless device 102. The wireless device 102 may contact the server 108 and request to download an application, for example, the application App 1. The server 108 may “tag” or mark the application with a geographic indicator. Further, the server 108 may transmit the application App 1 to the wireless device 102, as shown at path 118. The geographic indicator may indicate that the application App 1 may be operational or accessible when the wireless device 102 is within a geographic region, e.g., the region defined by the boundary 114. As long as the wireless device 102 remains within the geographic region defined by the boundary 114, App 1 will be accessible to the wireless device 102. However, if the wireless device 102 moves outside the bounded region, App 1 will be disabled or not accessible.

If the wireless device 102 transmits the application App 1 to the second wireless device 112, for example, by transmitting the application over path 120, the application will fail to function, because second wireless device 112 is outside the region defined by the boundary 114. Thus, the protection system operates to protect applications and content from unauthorized distribution because if the application and/or content are distributed to a device outside a predefined region associated with the application and/or content, the application and/or content will fail to operate, or the application and/or content will not be accessible to the device.

Also, if the wireless device 102 transmits the application App 1 to the second wireless device 112 via a Bluetooth connection, an radio frequency (RF) connection, an infrared (IR) connection, a wired connection, or some other wireless or wired connection and the second wireless device 112 is moved outside of the bounded region, App 1 may be disabled or not accessible.

In a particular aspect, however, when a user leaves the selected geographic region with second wireless device 112, the user may be prompted to purchase a license to access the content in the new area. The license may be an unlimited license, under which the user may access the content anywhere, i.e., the content is no longer protected based on the geographic region. Alternatively, the license may be a limited license, under which the user may access the content in the original geographic region and the new geographical area. In another aspect, the license may be a transfer license, under which the user has transferred his or her rights to access the content from the original geographic region to the new geographical area. For example, if a user moves, or travels, from a first location, e.g., Los Angeles, to a second location, e.g., San Diego, the user may transfer his or her rights.

In yet another aspect, the prompt may include an attempt to upsell to the user a less restrictive license (i.e., with greater area coverage), additional content, etc. The license may also be a limited transfer license in which content may be transferred by not accessed or executed.

Additionally, when a user attempts to superdistribute an application out of the geographic region defined by the boundary 114, e.g., to the second wireless device 112, the user may be warned that the application cannot be superdistributed out of that geographic region. Further, the user may be prompted to purchase a license, or rights, to superdistribute the application out of the geographic region. If the user chooses to purchase the license, he or she may be allowed to superdistribute the application as planned. In another aspect, superdistribution may be allowed, but access in the new region may be blocked. The user of the target device may be given an indication that access to the content is blocked—unless he or she purchases a license to access the content, as described herein.

It is to be understood that superdistribution includes distributing digital products, e.g., software, videos, recorded music, etc., either in an encrypted form or an unencrypted form over the Internet, another data network, using mobile technologies such as Bluetooth, IrDA or MMS (Multimedia Messaging Service), or a combination thereof.

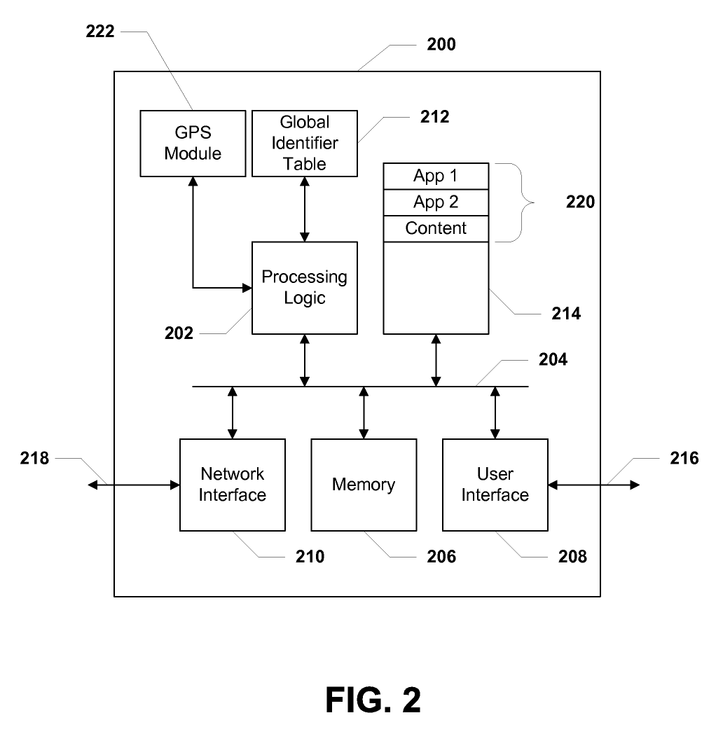

FIG. 2 shows a functional block diagram illustrating one aspect of a protection system 200 that operates to protect applications and content from unauthorized acquisition and/or distribution. For example, the protection system 200 is suitable for use in conjunction with or as part of the server 108 to protect applications and/or content, available at the server, which are downloaded to the wireless device 102.

As depicted in FIG. 2, the protection system 200 may include processing logic 202 that is coupled to an internal hub 204. Also coupled to the internal hub 204 are a memory 206, a user interface 208, and a network interface 210. The protection system 200 may also include a global identifier table 212 accessible to the processing logic 202 and an application memory 214 coupled to the internal bus 204. The application memory 214 comprises one or more applications and/or content 220 that are available for download.

In a particular aspect, the protection system 200 may include a global positioning system (GPS) module 222 coupled to the processing logic 202. The GPS module 222 and the processing logic 202 may provide a means for locating a device that is in communication with the protection system 200. Further, the GPS module 222, the global identifier table 212, and the processing logic 202 may provide a means for selectively controlling access to content and selectively controlling superdistribution of content according to one or more of the methods described herein.

In one or more aspects, the processing logic 202 comprises a CPU, a gate array, hardware logic, software, or a combination of hardware and software. Thus, the processing logic 202 may generally include logic to execute machine-readable instructions. In other words, the processing logic 202 may act as a means for executing one or more computer programs that may include the method steps disclosed herein.

The memory 206 may include random access memory (RAM), read only memory (ROM), flash memory, electrically erasable read only memory (EEROM), or any other suitable type of memory, or a combination thereof. In one aspect, the memory 206 is located internally to the protection system 200. In another aspect, the memory 206 comprises a removable memory card or memory device that may be selectively attached to the protection system 200 and thereby being coupled to the internal bus 204. Thus, the memory 206 may comprise virtually any type of memory that is capable of storing instructions that may be executed by the processing logic 202.

The user interface 208 receives user input 216, for example, from a keypad, a pointing device, a touch pad, or any other input mechanisms which allow a user to interact with the protection system 200. The user interface 208 may also be coupled to a display device, such as a cathode ray tube (CRT) display, a liquid crystal display (LCD), a light emitting diode (LED), or any other type of display device to provide a visual display to the user. Any other type of input or output device may also be coupled to the user interface 208, such as, disk storage, audio logic, video devices, etc.

The network interface 210 operates to transmit and receive information between the protection system 200 and external devices, systems, and/or networks using the communication link 218. For example, in one aspect, the network interface 210 comprises a radio transceiver circuit (not shown) that operates to transmit and receive information over a wireless data network using the communication link 218. For example, the communication link 218 may be the communication link 106 shown in FIG. 1. For example, the transceiver comprises circuitry that modulates information received from the processing logic 202 and converts the modulated information into high frequency signals suitable for wireless transmission. Similarly, the transceiver also comprises circuitry to convert received high frequency communication signals into signals suitable for demodulation and subsequent processing by the processing logic 202.

In another aspect, the network interface 210 comprises a transceiver that operates to transmit and receive information over a hardwired communication link, such as a telephone line, or other type of data line, to communicate with a remote system on a public data network, such as the Internet.

In still another aspect, the network interface 210 comprises circuitry that operates to communicate with local devices, such as a local workstation. The network interface 210 may also include circuitry (such as serial or parallel port logic) to communicate with a printer or other local computer or device, such as a floppy disk or a memory card. Thus, the network interface 210 may comprise any type of hardware, software, or combination thereof to allow the protection system 200 to communicate with other local or remotely located devices or systems.

In one aspect, the global identifier table 212 may be a data table, database, or some other data structure, that may include a list of applications and content titles, or content identifiers. Further, for each application or content title, the global identifier may include a geographic identifier. For example, the geographic identifier may be a set of coordinates, i.e., latitude and longitude, that set forth an area in which the content may be accessed or the application may be executed, or otherwise used. Further, the geographic identifier may set forth an area in which the content or application may be superdistributed and still be accessible. Otherwise, if the content or application is superdistributed outside of the area set forth by the geographic identifier, the content or application may be rendered inaccessible or unusable. The protection system 200 may use the global identifier table to protect the content within the wireless device 102, 112 from unauthorized access to the content when the wireless device 102, 112 is located within a region that the user has not purchased a license, or rights, to access the content. The protection system 200 may automatically check the global identifier table and the location of the wireless device 102, 112 prior to allowing accessing to any content on the wireless device 102, 112.

In a particular aspect, the geographic identifier may be a set of coordinates that corresponds to the vertices of a particular polygonal shape, e.g., a triangle, a quadrilateral, a rectangle, a square, a parallelogram, a rhombus, a trapezoid, a pentagon, a hexagon, a heptagon, an octagon, a nonagon, a decagon, or any other regular or irregular polygon. In another aspect, the geographic identifier may be a set of coordinates that correspond to a center of a circle or the center of multiple circles. Whether or not content or an application is located within the area set forth by a particular geographic identifier may provide selective control concerning access to the content or use of the application. In other words, if the content or application is not within a particular area the content or application may not be accessible, e.g., executable, shareable, runnable, etc. The location of the content or application may be determined by determining the location of the device in which the content or application is stored. The location of the content or application may be determined using a global positioning system (GPS) associated with the device in which the content or application is installed, or otherwise resides.

The geographic identifier may be defined by the user, e.g., when the user initially purchases the content or application, he or she may be prompted to input his or her zip code, area code, city name, state name, or other location identifier. After the user inputs his or her location identifier, the content or application may be associated with a geographic identifier setting forth the area in which the content or application may be accessed or used. The user may be able to reset, or re-define, these user preferences for free or for a nominal fee at any time while the content or application remains on the user device.

In another aspect, the geographic identifier may be defined by the creator of the content or the developer of the application. Further, the geographic identifier may be defined by some third party that controls distribution of the content or the application. Moreover, the geographic identifier may be defined by a content provider, e.g., the carrier that provides service to the user device. The geographic identifier may also be defined by a generic application programming interface (API) on the user device.

Additionally, the geographic identifier may be defined according to one or more enterprise rules. For example, a particular chain of coffee stores, or other business, may allow particular content or applications to be accessible within each store, or within a particular range of each store. As a user moves within range of the store, the content or application will become accessible. As the number of stores increases, the global identifier table may be dynamically updated to expand or supplement the geographic identifier associated with the content or application. Likewise, if the number of stores decreases the global identifier table may be dynamically updated to decrease the geographic identifier associated with the content or application.

It should be noted that the configuration of the protection system 200 is just one configuration suitable for implementing one aspect of the protection system 200. It is also possible to implement the protection system 200 using other functional elements or element configurations within the scope of the present invention.

During operation of the protection system 200, the processing logic 202 executes program instructions stored in the memory 206 to perform the functions described herein. For example, in one aspect, the protection system 200 performs the described functions when the processing logic 202 executes program instructions stored in the memory 206. In another aspect, the program instructions are stored on a computer-readable medium, such as a floppy disk, a compact disc (CD), a memory card, a flash memory device, a ROM, or any other type of memory device. The program instructions are loaded into the memory 206 via the network interface 210. For example, the protection system 200 may download the program instructions from the computer-readable medium into the memory 206 via the network interface 210.

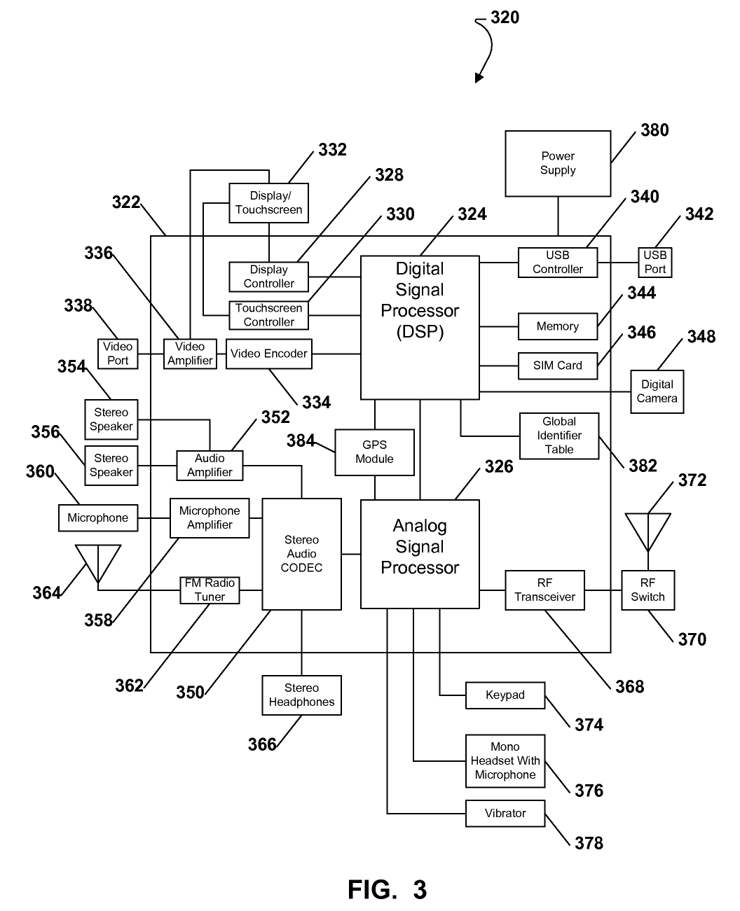

Referring to FIG. 3, an exemplary, non-limiting aspect of a wireless telephone is shown and is generally designated 320. As shown, the wireless telephone 320 includes an on-chip system 322 that includes a digital signal processor (DSP) 324 and an analog signal processor 326 that are coupled together. As illustrated in FIG. 3, a display controller 328 and a touchscreen controller 330 are coupled to the DSP 324. In turn, a touchscreen display 332 external to the on-chip system 322 is coupled to the display controller 328 and the touchscreen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the DSP 324. Further, a video amplifier 336 is coupled to the video encoder 334 and the touchscreen display 332. Also, a video port 338 is coupled to the video amplifier 336. As depicted in FIG. 3, a universal serial bus (USB) controller 340 is coupled to the DSP 324. Also, a USB port 342 is coupled to the USB controller 340. A memory 344 and a subscriber identity module (SIM) card 346 may also be coupled to the DSP 324. Further, as shown in FIG. 3, a digital camera 348 may be coupled to the DSP 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the wireless telephone 320 that require power. Further, in a particular aspect, the power supply is a rechargeable DC battery or a DC power supply that is derived from an alternating current (AC) to DC transformer that is connected to an AC power source.

FIG. 3 also shows that the wireless telephone 320 may also include a global identifier table 382. The global identifier table 382 may be similar to the global identifier table described above in conjunction with FIG. 2. Further, the global identifier table 382 may reside in the memory 344. The wireless telephone 320 may use the global identifier table to protect the content within the wireless telephone 320 from unauthorized access to the content when the wireless telephone 320 is located within a region that the use has not purchased a license, or rights, to access the content. The wireless telephone 320 may automatically check the global identifier table and the location of the wireless telephone 320 prior to accessing any content on the wireless telephone 320.

In a particular aspect, the wireless telephone 320 may include a global positioning system (GPS) module 384 coupled to the DSP 324 or the analog signal processor 326. The GPS module 384 and at least one of the processors 324, 326 may provide a means for locating the wireless device 320. Further, the GPS module 384, the global identifier table 382, and at least one of the processors 324, 326 may provide a means for selectively controlling access to content and selectively controlling superdistribution of content according to one or more of the methods described herein.

As depicted in FIG. 3, the touchscreen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322. The GPS module 384 may also be external to the on-chip system 322.

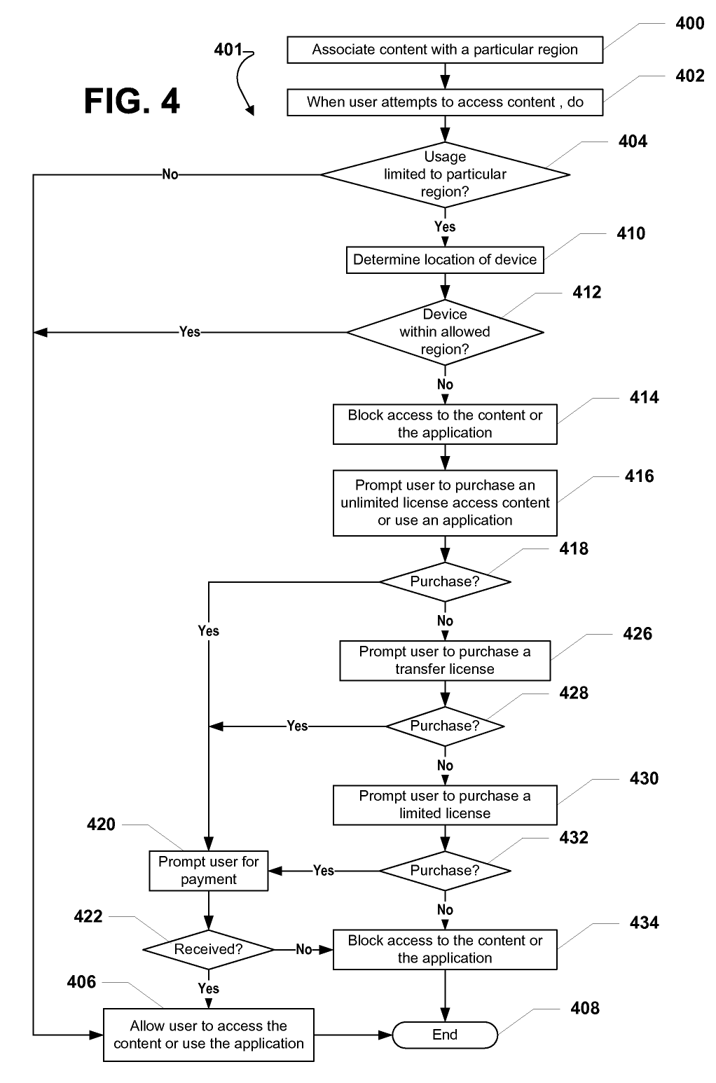

Referring to FIG. 4, a method of providing access to content and use of applications is shown and is generally designated 401. In a particular aspect, for example, the content may include audio, video, still photos, ring-tones, etc. Further, the applications may include software or computer programs executable, or otherwise usable, at a user device, e.g., a wireless telephone.

Commencing at block 400, content or an application may be associated with a particular region. At block 402, when a user attempts to access the content or use the application, a do loop is entered and the following steps are performed. At decision step 404, it may be determined whether the usage of the content or the application is limited to a particular region. If not, the method 401 may proceed to block 406 and the user may be allowed to access the content or use the application. Thereafter, the method 401 may end at 408.

Returning to decision step 404, if the usage of the application or content is limited to a particular region, the method 401 may move to block 410 and the location of the device may be determined. In a particular aspect, the location of the device may be determined using GPS. Alternatively, the location of the device may be determined using triangulation.

Proceeding to decision step 412, it may be determined whether the device is located within the allowed region, e.g., the region associated with the content or the application. If the device is located within the allowed region, the method 401 may proceed to block 406 and continue as described herein. Otherwise, if the device is not located within the allowed region, the method 401 may continue to block 414 and access to the content or application may be blocked.

At block 416, the user may be prompted to purchase an unlimited license to access the content or use the application. In other words, the user may be prompted to broaden the terms of the user's agreement with the carrier. The unlimited license may allow the user to access the content in any region.

Moving to decision step 418, it may be determined whether the user chooses to purchase the unlimited license to the content or application. If the user chooses to purchase the unlimited license, the method 401 may move to block 420 and the user may be prompted for payment. Thereafter, at decision step 422, it may be determined whether payment for the unlimited license is received from the user. If payment is received, the method 401 may proceed to block 406 and continue as described herein. Otherwise, if payment is not received, the method 401 may move to block 434 and the user may be prevented, or otherwise blocked, from accessing the content or using the application. Thereafter, the method 401 may end at 408.

Returning to decision step 418, if the user does not choose to purchase an unlimited license to use the content or the application, the method 401 may proceed to block 426 and the user may be prompted to purchase a transfer license. The transfer license may allow the user to transfer a previous license to use the content or the application from the allowed region to the region in which the user is currently located. For example, if a particular user purchased content or an application and only purchased a limited license to access the content or use the application in a particular state, but later moves to another state, the user may transfer the license to use the content or application to the new state.

Moving to decision step 428, it may be determined whether the user wants to purchase the transfer license in order to use the content in the new region. If the user chooses to purchase the transfer license, the method 401 may move to block 420 and continue as described herein. On the other hand, if the user does not choose to purchase the transfer license, the method 401 may move to block 430 and the user may be prompted to purchase a limited license to use the content or the application in the new region. The limited license may limit the use of the content or the application in the new region for a limited time period, e.g., a day, a week, a month, etc.

Continuing to decision step 432, it may be determined whether the user chooses to purchase the limited license to use the content or application. If so, the method 401 may move to block 420 and continue as described herein. Conversely, if the user does not choose to purchase the limited license to access the content or the application for a limited time, the method 401 may proceed to block 434 and the user may be blocked from the accessing the content or from using the application. Thereafter, the method 401 may end at 408.

It may be appreciated that a computer program may comprise the method steps described above. Further, the computer program may be executed within a wireless device to control access to content. As such, the wireless device may be considered self-protecting. In another aspect, the computer program may be executed within a server that provides access to a data network. In yet another aspect, the computer program may be executed within another third party server in order to protect content and control access to the content.

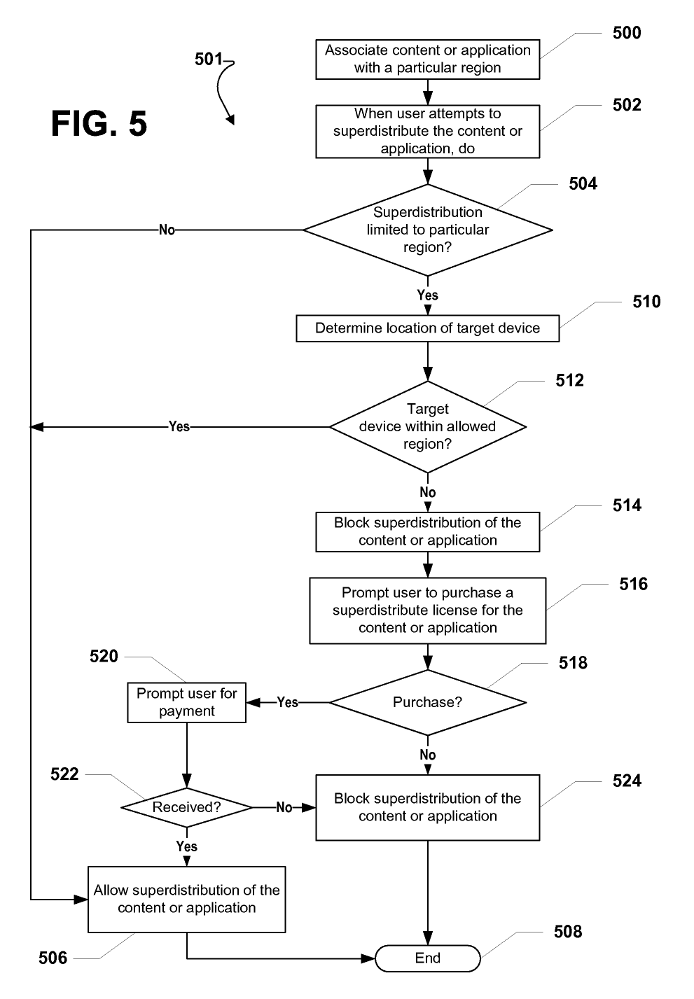

FIG. 5 illustrates a method of providing superdistribution of content and applications, generally designated 501. Beginning at block 500, content or an application may be associated with a particular region. At block 502, when a user attempts to superdistribute the content or the application, a do loop is entered and the following steps are performed. At decision step 504, it may be determined whether superdistribution of the content or the application is limited to a particular region. If not, the method 501 may proceed to block 506 and the user may be allowed to superdistribute the content or use the application. Thereafter, the method 501 may end at 508.

Returning to decision step 504, if superdistribution of the application or content is limited to a particular region, the method 501 may move to block 510 and the location of the device may be determined. In a particular aspect, the location of the target device may be determined using GPS.

Proceeding to decision step 512, it may be determined whether the target device is located within the allowed region, e.g., the region associated with the content or the application. If the device is located within the allowed region, the method 501 may proceed to block 506 and continue as described herein. Otherwise, if the device is not located within the allowed region, the method 501 may continue to block 514 and the superdistribution of the may be blocked. At block 516, the user may be prompted to purchase superdistribution license that will allow the user to superdistribute the content or the application to the targeted device. For example, a user may wish to superdistribute the content or the application as a gift to a friend or relative. The user may purchase the content for superdistribution for himself or herself or as a gift for someone else.

Moving to decision step 518, it may be determined whether the user chooses to purchase the superdistribution license for the content or application. If the user chooses to purchase the superdistribution license, the method 501 may move to block 520 and the user may be prompted for payment. Thereafter, at decision step 522, it may be determined whether payment is received from the user. If payment is received, the method 501 may proceed to block 506 and continue as described herein. Otherwise, if payment is not received, the method 501 may move to block 524 and the user may be blocked, or otherwise prevented, from superdistributing the content or the application. Thereafter, the method 501 may end at 508.

Returning to decision step 518, if the user does not choose to purchase the superdistribution license for the content or the application, the method 501 may proceed to block 524 and superdistribution of the content may be blocked. Thereafter, the method 501 may end at 508.

It may be appreciated that a computer program may comprise the method steps described above. Further, the computer program may be executed within a wireless device to control superdistribution of content. As such, the wireless device may be considered self-protecting. In another aspect, the computer program may be executed within a server that provides access to a data network. In yet another aspect, the computer program may be executed within another third party server in order to protect content and limit superdistribution of the content.

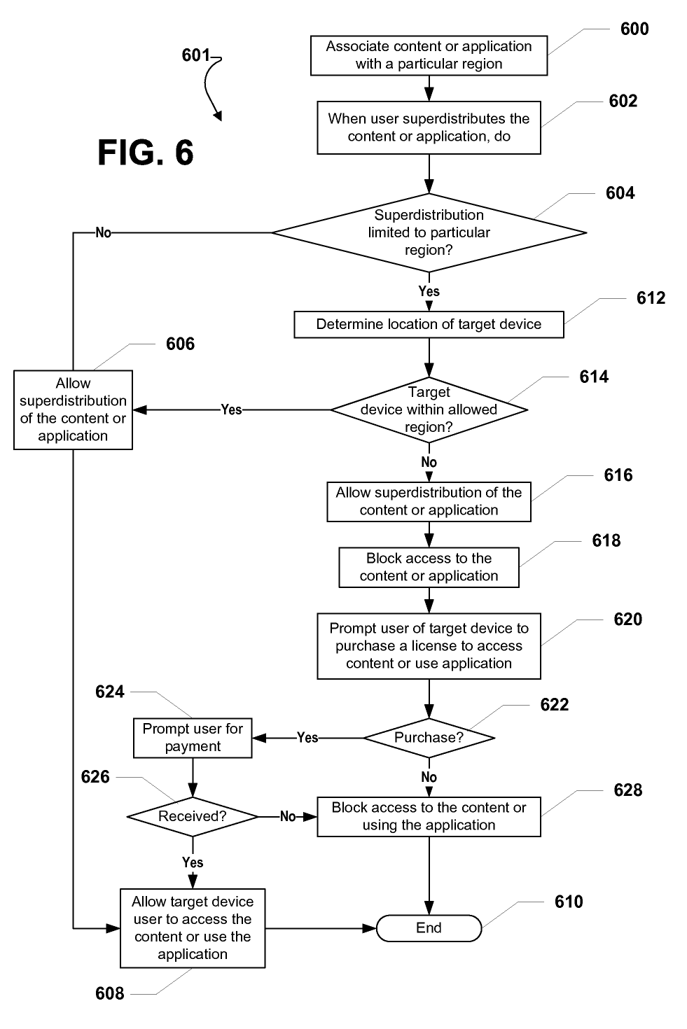

Referring now to FIG. 6, another aspect of a method of providing superdistribution of content and applications is shown and is designated 601. Beginning at block 600, content or an application may be associated with a particular region. At block 602, when a user superdistributes, or attempts to superdistribute, the content or the application, a do loop is entered and the following steps are performed. At decision step 604, it may be determined whether superdistribution of the content or the application is limited to a particular region. If not, the method 601 may proceed to block 606 and the user may be allowed to superdistribute the content or the application. At block 608, the user of the target device may be allowed to access the content or use the application. Thereafter, the method 601 may end at 610.

Returning to decision step 604, if superdistribution of the application or content is limited to a particular region, the method 601 may move to block 612 and the location of the target device may be determined. In a particular aspect, the location of the target device may be determined using GPS.

Proceeding to decision step 614, it may be determined whether the target device is located within the allowed region, e.g., the region associated with the content or the application. If the target device is located within the allowed region, the method 601 may proceed to block 606 and continue as described herein. Otherwise, if the device is not located within the allowed region, the method 601 may move to block 616 and superdistribution of the content or application may be allowed. However, at block 618, access to the content or application may be blocked.

Continuing to block 620, the user may be prompted to purchase a license to access the content or use the application. Moving to decision step 622, it may be determined whether the user chooses to purchase the license to access the content or use the application. If the user chooses to purchase the license to access the content or use the application, the method 601 may move to block 624 and the user may be prompted for payment. Thereafter, at block 626, it may be determined whether payment is received from the user. If payment is received, the method 601 may proceed to block 608 and continue as described herein. Otherwise, if payment is not received, the method 601 may move to block 628 and access to the content or application may be blocked. Thereafter, the method 601 may end at 610.

Returning to decision step 622, if the user does not choose to purchase a license to access the content or the application, the method 601 may proceed to block 628 and access to the content or application may be blocked. Thereafter, the method 601 may end at 610.

It may be appreciated that a computer program may comprise the method 601 steps described above. Further, the computer program may be executed within a wireless device to control superdistribution of content. As such, the wireless device may be considered self-protecting. In another aspect, the computer program may be executed within a server that provides access to a data network. In yet another aspect, the computer program may be executed within another third party server in order to protect content and limit superdistribution of the content.

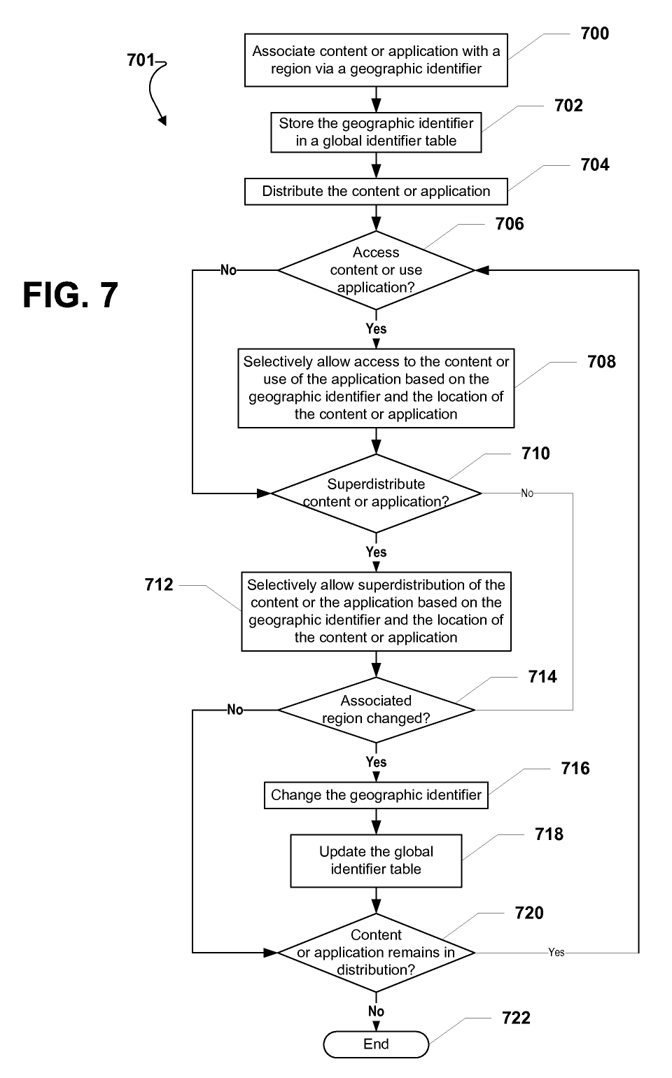

FIG. 7 depicts a method of dynamically updating a global identifier table associated with content and applications. The method is designated 701. Beginning at block 700, content or an application may be associated with a region via a geographic identifier. At block 702, the geographic identifier may be stored in a global identifier table. Further, at block 704, the content or application may be distributed, e.g., to one or more user devices. For example, the user device may be any of the user devices described herein.

Moving to decision step 706, it may be determined whether a user is attempting to access the content or use the application. If so, the method 701 may move to block 708 and the user may be selectively allowed to access the content or use the application based on the geographic identifier and the location of the content or the application. For example, access to the content or use of the application may be determined using one of the method 701 s described herein. Thereafter, the method 701 may proceed to decision step 710.

Returning to decision step 706, if the user is not attempting to access the content or use the application, the method 701 may move directly to decision step 710. At decision step 710, it may be determined whether the user is attempting to superdistribute the content or the application. If so, the method 701 may proceed to block 712 and the user may be selectively allowed to superdistribute the content or the application based on the geographic identifier and the location of the content or application. For example, the superdistribution may be controlled using one of the method 701s described herein. From block 712, the method 701 may move to decision step 714. Returning to decision step 710, if the user does not attempt to superdistribute the content or the application, the method 701 may proceed directly to decision step 714.

At decision step 714, it may be determined whether a region associated with the content or the application is changed. The associated region may be changed by the user. For instance, the associated region may be changed by the user for a fee. Further, the associated region may be changed by the owner of the content or the application, e.g., to expand distribution of the content or the application. Also, the associated region may be changed by a service provider. If the associated region is changed, the method 701 may continue to block 716 and the geographic identifier for the content or the application may be changed. For example, the geographic identifier may be replaced with a different geographic identifier, supplemented with another geographic identifier, or simply expanded to increase the size of the geographic region associated with the content or the application. Thereafter, at block 718, the global identifier table may be updated to represent the change. From block 718, the method 701 may move to decision step 720. Returning to decision step 714, if the associated region is not changed, the method 701 may move directly to decision step 720. At decision step 720, it may be determined whether the content or the application remains in distribution. For example, the user may have deleted the content or the application from the user device. Also, the owner of the content or the application may have recalled the content or the application—in which case the content or the application is no longer available on the user device. If the content or the application remains in distribution, the method 701 may return to decision step 706 and continue as described herein. If the content or application does not remain in distribution, the method 701 may end at 722.

It is to be understood that the method steps described herein need not necessarily be performed in the orders described. Further, words such as “thereafter,” “then,” “next,” etc. are not intended to limit the order of the steps. These words are simply used to guide the reader through the description of the method steps.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of providing access to content within a device, the method comprising:
determining a location of the content;
determining whether the content is within an allowed region; and
selectively prompting a user to purchase a license to access the content.

2. The method of claim 1, wherein the user is prompted to purchase the license to access the content when the content is not within an allowed region.

3. The method of claim 1, further comprising:
determining that the content is located within an allowed region; and
allowing access to the content.

4. The method of claim 1, further comprising:
determining that the license is purchased; and
allowing access to the content.

5. The method of claim 1, wherein the license is an unlimited license to access the content.

6. The method of claim 1, wherein the license is a limited license to access the content in a new region.

7. The method of claim 6, wherein the limited license allows access to the content for a time period.

8. The method of claim 1, wherein the license is a transfer license that transfers rights to access to content from a first region to a second region.

9. The method of claim 1, wherein the location of the content is determined by locating a device in which the content resides.

10. The method of claim 1, wherein the content includes at least one of the following: audio content, video content, a photograph, a ring-tone, and software.

11. A wireless device used to access content, the wireless device comprising:
means for determining a location of the content;
means for determining whether the content is within an allowed region; and
means for selectively prompting a user to purchase a license to access the content.

12. The wireless device of claim 11, further comprising:
means for determining that the content is located within an allowed region; and
means for allowing access to the content.

13. The wireless device of claim 11, further comprising:
means for determining that the license is purchased; and
means for allowing access to the content.

14. A server providing access to content, the server comprising:
means for determining a location of the content;
means for determining whether the content is within an allowed region; and
means for selectively prompting a user to purchase a license to access the content.

15. The server of claim 14, further comprising:
means for determining that the content is located within an allowed region; and
means for allowing access to the content.

16. The server of claim 14, further comprising:
means for determining that the license is purchased; and
means for allowing access to the content.

17. A computer program product comprising:
a computer-readable medium comprising:
at least one instruction for determining a location of the content;
at least one instruction for determining whether the content is within an allowed region; and
at least one instruction for selectively prompting a user to purchase a license to access the content.

18. The computer program of claim 17, wherein the computer-readable medium further comprises:
at least one instruction for determining that the content is located within an allowed region; and
at least one instruction for allowing access to the content.

19. The computer program of claim 17, wherein the computer-readable medium further comprises:
at least one instruction for determining that the license is purchased; and
at least one instruction for allowing access to the content.

20. A method of controlling superdistribution of content to a target device, the method comprising:
determining a location of the target device;
determining whether the target device is within an allowed region; and
selectively blocking superdistribution of the content to the target device based at least partially on the location of the target device.

21. The method of claim 20, wherein superdistribution of the content is allowed when the target device is within the allowed region.

22. The method of claim 20, wherein superdistribution of the content is blocked when the target device is not within the allowed region.

23. The method of claim 22, further comprising:
prompting a user of the device to purchase a superdistribution license to superdistribute the content outside the allowed region.

24. The method of claim 23, further comprising:
determining that the superdistribution license is purchased; and
allowing superdistribution of the content outside of the allowed region.

25. The method of claim 24, further comprising:
determining that the superdistribution license is not purchased; and
blocking superdistribution of the content outside of the allowed region.

26. A wireless device used to access content, the wireless device comprising:
means for determining a location of the target device;
means for determining whether the target device is within an allowed region; and
means for selectively blocking superdistribution of the content to the target device based at least partially on the location of the target device.

27. The wireless device of claim 26, further comprising:
means for prompting a user of the device to purchase a superdistribution license to superdistribute the content outside the allowed region.

28. The wireless device of claim 26, further comprising:
means for determining that the superdistribution license is purchased; and
means for allowing superdistribution of the content outside of the allowed region.

29. The wireless device of claim 27, further comprising:
means for determining that the superdistribution license is not purchased; and
means for blocking superdistribution of the content outside of the allowed region.

30. A server providing access to content, the server comprising:
means for determining a location of the target device;
means for determining whether the target device is within an allowed region; and
means for selectively blocking superdistribution of the content to the target device based at least partially on the location of the target device.

31. The server of claim 30, further comprising:
means for prompting a user of the device to purchase a superdistribution license to superdistribute the content outside the allowed region.

32. The server of claim 30, further comprising:
means for determining that the superdistribution license is purchased; and
means for allowing superdistribution of the content outside of the allowed region.

33. The server of claim 31, further comprising:
means for determining that the superdistribution license is not purchased; and
means for blocking superdistribution of the content outside of the allowed region.

34. A computer program product comprising:
a computer-readable medium comprising:
at least one instruction for determining a location of the target device;
at least one instruction for determining whether the target device is within an allowed region; and
at least one instruction for selectively blocking superdistribution of the content to the target device based at least partially on the location of the target device.

35. The computer program product of claim 34, wherein the computer-readable medium further comprises:
at least one instruction for providing a prompt at the device to purchase a superdistribution license to superdistribute the content outside the allowed region.

36. The computer program product of claim 35, wherein the computer-readable medium further comprises:
at least one instruction for determining that the superdistribution license is purchased; and
at least one instruction for allowing superdistribution of the content outside of the allowed region.

37. The computer program product of claim 36, wherein the computer-readable medium further comprises:
at least one instruction for determining that the superdistribution license is not purchased; and
at least one instruction for blocking superdistribution of the content outside of the allowed region.
